(19) United States
(12) Patent Application Publication
(10) Pub. No.: US 2026/0234444 A1
(43) Pub. Date: Aug. 13, 2026

(54) COLOR PROTECTIVE FILM FOR VEHICLES CAPABLE OF DRY APPLICATION AND METHOD FOR APPLYING THE SAME TO VEHICLES

(71) Applicant: STEK CO., LTD., Seoul (KR)

(72) Inventors: Chang Suk LEE, Cheonan-si (KR); Sang Tae KIM, Cheonan-si (KR); Seung Hwan BAEK, Cheonan-si (KR)

(73) Assignee: STEK CO., LTD., Seoul (KR)

(21) Appl. No.: 19/393,677

(22) Filed: Nov. 19, 2025

(30) Foreign Application Priority Data
Feb. 7, 2025 (KR) 10-2025-0015728

(51) Int. Cl. C09J 7/29; C09J 7/38; C09J 7/40

(52) U.S. Cl. CPC C09J 7/29; C09J 7/385; C09J 7/403; C09J 2203/354; C09J 2301/162; C09J 2301/414; C09J 2475/005; C09J 2475/006; C09J 2483/006

(57) ABSTRACT

The present invention relates to a color protective film for vehicles capable of dry application and a method for applying the same to vehicles, wherein the color protective film for vehicles of the present invention can also be applied in a dry state due to significantly improved application property, such as the application of an air track pattern that has an appropriately low tensile strength and facilitates the discharge of air bubbles.

### CROSS-REFERENCE TO RELATED APPLICATION

This application claims priority to and the benefit of Korean Patent Application No. 10-2025-0015728, filed on Feb. 27, 2005, the disclosure of which is incorporated herein by reference in its entirety.

### BACKGROUND

### 1. Field of the Invention

The present invention relates to a color protective film for vehicles capable of dry application and a method for applying the same to vehicles, and more particularly, to a color protective film for vehicles, which can also be applied in a dry state due to significantly improved application property, such as the application of an air track pattern that has an appropriately low tensile strength and facilitates the discharge of air bubbles, and a method for applying the same to vehicles.

### 2. Discussion of Related Art

In the existing vehicle market, colors were implemented through paint, and customers could choose the colors and purchase a vehicle, whereas recently, due to the fact that the painting process does not allow for a wide range of colors to be released and it is coupled with the market trend of minimizing the painting process due to recent environmental concerns, films that can change the color of vehicles are being sold in the form of wrapping films.

Conventional wrapping films are made of a PVC material, which is relatively inelastic and thus has a low resilience when stretched to be applied to a vehicle, so they are attached well in an applied form. In addition, the adhesive strength thereof is not high. For this reason, wrapping films made of a PVC material could be applied in a dry state.

The next product is a paint protection film (PPF), developed using a thermoplastic polyurethane (TPU) material, and is a product designed to protect the painted surface of a vehicle from external damage and harm such as stone chips and scratches, based on the excellent elasticity of the TPU material.

A product additionally made of such a transparent PPF is a color PPF produced by adding a color to a PPF, and a color may be implemented by additionally coating an adhesive layer to which organic/inorganic pigments are added, thereby implementing colors desired by customers and adding protection performance.

However, this method requires a lot of time and money to produce a wide variety of products in small quantities because coating is carried out by a continuous process, so that the method has a disadvantage of having inventory burden and high costs because various colors need to be prepared in order to meet the demands of the market where it is not clear what colors customers want.

In addition, the PPF has high elastic force because it is a main purpose to protect the painted surface of a vehicle with excellent elasticity, and therefore, the PPF needs to have high adhesive strength to be applied to vehicles with many curved surfaces and maintain attachment, and since it is difficult to perform this type of PPF application in a dry state, the PPF is applied in a wet state.

Since it takes a longer time for this type of wet application to be performed than dry application and an additional work needs to be done after a part in which the application has been performed in a wet state is dried, most application is difficult and time-consuming except for professional application workers.

### RELATED ART DOCUMENTS

### Patent Document

Korean Patent Publication No. 10-2016-0149391

### SUMMARY OF THE INVENTION

Thus, a problem to be solved by the present invention is to provide a color protective film for vehicles, which can also be applied in a dry state due to significantly improved application property, such as the application of an air track pattern that has an appropriately low tensile strength and facilitates the discharge of air bubbles.

Another problem to be solved by the present invention is to provide a method for applying the color protective film for vehicles to a vehicle.

The problems of the present invention are not limited to the aforementioned technical problems, and other technical problems, which have not been mentioned, may be clearly understood by a person with ordinary skill in the art from the following description.

Specific details of other embodiments according to an embodiment of the present invention for solving the above problems are included in the detailed description.

### BRIEF DESCRIPTION OF THE DRAWINGS

FIG. 1 is a cross-sectional view showing a stacked structure of a color protective film for vehicles according to an embodiment of the present invention.

FIG. 2 is a set of images showing the impact resistance test results of a color protective film for vehicles according to the experimental example of the present invention.

FIG. 3 is a set of images showing the scratch recovery test results of a color protective film for vehicles according to the experimental example of the present invention.

FIG. 4 is a set of images showing the water repellency test results of a color protective film for vehicles according to the experimental example of the present invention.

FIG. 5 is a set of photographs of the adhesive surface of a color protective film for vehicles according to the experimental example of the present invention.

FIG. 6 is a set of photographs of the product surface of a color protective film for vehicles according to the experimental example of the present invention.

FIG. 7 is a set of images showing the results of evaluating the adhesive tack of a color protective film for vehicles according to the experimental example of the present invention.

FIG. 8 is a graph showing the results of evaluating the tensile strength of a color protective film for vehicles according to the experimental example of the present invention.

FIG. 9 is a photograph showing the surface of a release film having an air track pattern according to an embodiment of the present invention.

### DETAILED DESCRIPTION OF EXEMPLARY EMBODIMENTS

The benefits and features of the present invention, and the methods of achieving the benefits and features will become apparent with reference to embodiments to be described below in detail. However, the present invention is not limited to the embodiments to be disclosed below and may be implemented in various other forms, and the embodiments are only provided for rendering the disclosure of the present invention complete and for fully representing the scope of the invention to a person with ordinary skill in the technical field to which the present invention pertains, and the present invention will be defined only by the scope of the claims.

The terms used in the present specification are used merely to describe embodiments, and are not intended to limit the present invention. In the present specification, the ‘and/or’ includes each and all combinations of one or more of the items mentioned. Further, the singular form includes the plural forms unless specifically stated in a phrase. The terms ‘comprises’ and/or ‘comprising’ used in the specification do not exclude the presence or addition of one or more other constituent elements in addition to the referenced constituent elements. The numerical range indicated by using ‘-’ or ‘to’ indicates a numerical range including values described before and after it as a lower limit and an upper limit, respectively, unless otherwise stated. ‘About’ or ‘approximately’ means a value or numerical range within 20% of the value or numerical range described thereafter.

In describing the constituent elements of the examples of the present invention, terms such as first, second, A, B, (a), and (b) may be used. These terms are merely for distinguishing one constituent element from another, and the nature, turn, or order of the corresponding constituent element is not limited by the term.

Since the size and thickness of each component shown in the drawings may be arbitrarily shown for the convenience of explanation, the present invention is not necessarily limited to those shown in the drawings. In the drawings, in order to clearly express several layers and regions, their thickness may be enlarged. Moreover, in the drawings, the thicknesses of some layers and regions may be exaggerated for convenience of explanation.

A case where a part such as a layer, a film, a region, and a plate is present “under” or “at a lower portion of” another part includes not only a case where the part is present “immediately under” another part, but also a case where still another part is present therebetween, unless otherwise specified. In addition, a case of being ‘above’ or ‘on’ a reference part means being located above or below the reference part, and does not necessarily mean being located ‘above’ or ‘on’ in the opposite direction of gravity.

The description ‘on a plane’ means that a target part is viewed from above, and the description ‘on a cross section’ means that the target part is cut vertically and viewed from the side.

Unless otherwise defined, all the terms (including technical and scientific terms) used in the present specification will be able to be used as a meaning which may be commonly understood to a person with ordinary skill in the art to which the present invention pertains. In addition, the terms defined in generally used dictionaries are not to be interpreted ideally or excessively unless clearly and specifically defined.

Moreover, in describing the embodiments of the present invention, when it is determined that the specific description of relevant known configurations or functions obstructs the understanding for the embodiments of the present invention, the detailed description thereof will be omitted.

Hereinafter, the embodiments of the present invention will be described in detail with reference to the accompanying drawings.

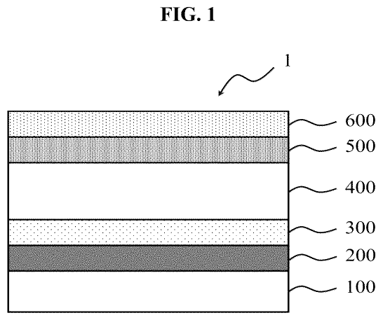

FIG. 1 is a cross-sectional view showing a stacked structure of a color protective film for vehicles according to an embodiment of the present invention.

Referring to FIG. 1, a color protective film for vehicles 1 includes an adhesive layer 200, a color layer 300 disposed on the adhesive layer 200, a substrate layer 400 disposed on the color layer 300, and a self-healing layer 500 disposed on the substrate layer 400.

In addition, the color protective film for vehicles 1 may further include one or more of a silicone protective film 600 disposed on the self-healing layer 500 and a release film 100 disposed under the adhesive layer 200.

### Substrate Layer

The substrate layer 400 may include a thermoplastic polyurethane (TPU).

Since the substrate layers of conventional color protective films for vehicles are made of PVC, and thus have relatively weak physical properties such as elasticity or tensile strength, there is a problem in that the substrate layer is not suitable for protecting the painted surface of a vehicle other than changing the color of the vehicle.

In contrast, since the substrate layer of the present invention includes a thermoplastic polyurethane, the substrate layer may exhibit high elasticity, and thus may prevent the painted surface of the vehicle from being damaged by external impact. That is, a color protective film for vehicles having excellent impact resistance may be implemented by forming a substrate layer with a thermoplastic polyurethane.

The thermoplastic polyurethane included in the substrate layer may be a non-yellowing thermoplastic polyurethane. The non-yellowing thermoplastic polyurethane may be an aliphatic thermoplastic polyurethane.

The thermoplastic polyurethane may yellow when exposed to ultraviolet light. This phenomenon is usually confirmed in products where pigments are directly added to a thermoplastic polyurethane. Since the color protective film for vehicles of the present invention has a separate color layer without directly adding a color to a substrate layer, yellowing may be relatively unlikely to occur.

In addition, by using a non-yellowing thermoplastic polyurethane such as an aliphatic thermoplastic polyurethane for the substrate layer, the yellowing may be further suppressed, and the discoloration or decolorization of a color layer disposed below the substrate layer may also be prevented.

The thermoplastic polyurethane included in the substrate layer makes application property excellent, so that a thermoplastic polyurethane having a hardness of Shore 85-93A may be used to enable dry application.

In an embodiment, the substrate layer may be a thermoplastic polyurethane film including only 100% thermoplastic polyurethane.

The thickness of the substrate layer may be 75 to 250 μm, specifically 100 to 130 μm, and more specifically 110 to 120 μm. Color protective films for vehicles require stretching in order to be applied through wrapping, but when the tensile strength is too high, the films are not likely to be stretched, making wrapping more difficult and causing the quality of the finish to deteriorate, such as the occurrence of lifting, particularly on curved surfaces or edge portions. In particular, this phenomenon may be more pronounced in dry application than in wet application.

Therefore, when the thickness of the substrate layer is within the above range, the color protective film for vehicles may have an appropriately low tensile strength enough to enable dry application without any difficulties, and the total thickness of the color protective film for vehicles satisfies about 200 μm, so that the painted surface of the vehicle may be stably protected.

### Self-Healing Layer

The self-healing layer 500 may include polyurethane methacrylate and an isocyanate curing agent.

Conventional self-healing layers have problems such as poor recovery from scratches generated on the surface and low water repellency, making the layers susceptible to external contamination. The self-healing layer of the present invention including the above-mentioned components has high elasticity, and thus may repair scratches generated on the film surface, and has high water repellency, and thus may suppress the contamination of the film surface. In addition, because the self-healing layer of the present invention has soft characteristics, application property may be greatly improved.

The self-healing layer may include 75 to 90 parts by weight of polyurethane methacrylate and 15 to 40 parts by weight of an isocyanate curing agent. When the composition of the self-healing layer is within the above range, it is possible to implement self-healing properties which heal scratches generated on the surface by itself, and to implement excellent water repellency suitable for preventing contamination from occurring on the surface.

The thickness of the self-healing layer may be 5 to 40 μm, specifically 8 to 20 μm, and more specifically 8 to 15 μm. When the thickness of the self-healing layer is within the above range, the color protective film for vehicles may have an appropriate scratch resistance and stain resistance, and the total thickness of the color protective film for vehicles satisfies about 200 μm, so that the painted surface of the vehicle may be stably protected.

### Color Layer

The color layer 300 may include a thermoplastic polyurethane, an isocyanate curing agent, and a colored pigment.

Conventional color layers are made of an acrylic resin, and thus have a disadvantage in that physical properties such as elasticity or tensile strength deteriorate. In addition, since the substrate layer is coated with the color layer in the form of an acrylic resin, it is not possible to store the color layer as a separate semi-finished product, so that there is a problem in that a large quantity of products need to be produced at a time.

In contrast, the color layer of the present invention includes the above-mentioned components, and thus has excellent physical properties such as elasticity or tensile strength compared to conventional color layers made of an acrylic resin. In addition, since the color layer is thermally laminated to the substrate layer using a hot melt method to manufacture a semi-finished product in the form of a separate sheet, and then an adhesive layer and a self-healing layer may be coated and laminated as needed during application to use the color protective film for vehicles, the color protective film for vehicles is very advantageous for long-term storage and production of a wide variety of products in small quantities. The hot melt method means a method of attaching a color layer by applying heat to a thermoplastic resin, and the color layer of the present invention can be attached by the hot melt method by employing a urethane-based material which is the same as that of a substrate layer.

The color layer may include 80 to 90 parts by weight of a thermoplastic polyurethane, 5 to 8 parts by weight of an isocyanate curing agent, and 10 to 20 parts by weight of a colored pigment. When the composition of the color layer is within the above range, the color layer can be formed into a stable semi-finished product that can be stored for a long period of time and hot melt laminated, and various colors may be implemented, attachment properties may be improved, and the color layer may act as a primer to prevent transfer.

In addition, the color protective film for vehicles of the present invention may include a separate color layer to reduce the effect of the yellowing of the substrate layer on the color change of the color protective film for vehicles.

The thickness of the color layer may be 5 to 60 μm, specifically 10 to 40 μm, and more specifically 15 to 30 μm. When the thickness of the color layer is within the above range, it is possible to form an appropriate semi-finished product form, and the total thickness of the color protective film for vehicles satisfies about 200 μm, so that the painted surface of the vehicle may be stably protected.

### Adhesive Layer

The adhesive layer 200 may include an acrylic copolymer and an epoxy curing agent, and may have an air track pattern formed thereon.

Since conventional thermoplastic polyurethane-based protective films have high elasticity, the adhesive layer needs to have high adhesive strength and adhesive tack to ensure that the finish becomes normal on the edge portions of the vehicle without lifting. The process of applying a protective film to a vehicle is not a simple one-time attachment, but requires a process of repeated attachment and detachment to allow the protective film to stay in place, and since conventional protective films have high adhesive strength and adhesive tack, this process cannot be performed with dry application as they leave marks, so that application can only be performed in a wet state.

Since the color protective film for vehicles of the present invention appropriately lowers tensile strength by reducing the thickness of the substrate layer, there is an effect in that not only wrapping is easily performed, but also the adhesive strength and adhesive tack of the adhesive layer need not be high. Accordingly, the adhesive layer is allowed to include the above-mentioned components, and thus has relatively hard properties, thereby making it possible to appropriately lower the adhesive strength and adhesive tack. In addition, since air bubbles can be easily discharged by an air track pattern, the color protective film for vehicles of the present invention is very suitable for dry application.

The air track pattern formed on the adhesive layer may specifically refer to a lattice-shaped pattern engraved on the adhesive layer by emboss or intaglio, and the embodiment of the present invention is not limited to this shape and may be any pattern regardless of its shape as long as the pattern can provide a passage capable of discharging air bubbles generated during application of a color protective film for vehicles.

The air track pattern formed on the adhesive layer may be transferred while a release film having a corresponding pattern is laminated to a plain adhesive layer. Accordingly, the same pattern may be at least partially formed not only on an adhesive layer but also on one or more of a color layer, a substrate layer, a self-healing layer, and a silicone protective film disposed on the adhesive layer. However, the embodiments of the present invention are not limited thereto.

The size of the air track pattern may be 0.05 to 1 mm, specifically 0.1 to 0.4 mm, and more specifically 0.2 to 0.3 mm. The size of the air track pattern may refer to the length of one side of each grid (or the diameter in the case of a circle). The depth of the air track pattern may be 1 to 20 μm, specifically 5 to 10 μm. The color protective film for vehicles of the present invention may easily discharge air bubbles even when a small air track pattern is applied as described above, and since the pattern size is small, phenomena such as orange peel (OP) are minimized, so that the color protective film may have excellent appearance.

The adhesive layer may include 94 to 99 parts by weight of an acrylic copolymer and 0.5 to 5 parts by weight of an epoxy curing agent. When the composition of the adhesive layer is within the above range, the adhesive strength and adhesive tack are appropriately low, so that dry application can be performed and the finish of the edge portion of the vehicle may be normally achieved.

The thickness of the adhesive layer may be 10 to 70 μm, specifically 20 to 50 μm, and more specifically 30 to 40 μm. When the thickness of the adhesive layer is within the above range, the color protective film for vehicles has properties suitable for dry application and the total thickness of the color protective film for vehicles satisfies about 200 μm, so that the painted surface of the vehicle may be stably protected.

### Release Film

The release film 100 may include a PET film and silicone, and may have a pattern corresponding to the air track pattern formed.

The release film may protect the adhesive layer until the color protective film for vehicles of the present invention is attached to the painted surface of a vehicle. It is preferred that the release film has a weak peel strength because the release film needs to be easily removed by an application worker during application of the color protective film for vehicles. In an embodiment, the release film may include any common release film that has a weak peel strength and has difficulty in increasing its peel strength over time while being attached to the adhesive layer.

In particular, in order to form an air track pattern on the adhesive layer, the release film may have a pattern corresponding to the air track pattern formed thereon. Such a pattern may be transferred to the adhesive layer while a release film is laminated to the adhesive layer. The pattern corresponding to the air track pattern of the adhesive layer may mean that those formed on the release film and those formed on the adhesive layer have the shapes of emboss and intaglio or intaglio and emboss. However, the embodiments of the present invention are not limited thereto.

The thickness of the release film may be 100 to 150 μm, specifically 120 to 140 μm, and more specifically about 130 μm.

### Silicone Protective Film

The silicone protective film 600 may include a PET film and silicone.

The silicone protective film is a film for protecting the surface of a product, and conventional products with a silicone low-adhesive coating on a PET film may also be used.

The thickness of the silicone protective film may be 30 to 80 μm, specifically 50 to 60 μm, and more specifically about 54 μm.

A method for manufacturing a color protective film for vehicles according to an embodiment of the present invention includes: (a) preparing a semi-finished product of a color protective film for vehicles by laminating a color layer to a substrate layer using a hot melt method; (b) coating a self-healing layer on the substrate layer of the semi-finished product and an adhesive layer under the color layer to form the self-healing layer and the adhesive layer; and (c) laminating a release film under the adhesive layer.

In addition, the method may further include laminating a silicone protective film on the self-healing layer. A description of each layer will be omitted because it has been described above.

Hereinafter, the present invention will be described through Experimental Examples, but it is obvious that the effects of the present invention are not limited by the following Experimental Examples.

### PREPARATION EXAMPLES

### Example 1

A self-healing layer having a thickness of 10 μm was formed by coating the upper surface of a substrate layer including a thermoplastic polyurethane film having a thickness of 120 μm with 85 parts by weight of polyurethane methacrylate and 20 parts by weight of an isocyanate curing agent. A color layer having a thickness of 20 μm was formed by coating the lower surface of the substrate layer with 84 parts by weight of a thermoplastic polyurethane, 7 parts by weight of an isocyanate curing agent, and 16 parts by weight of a colored pigment. For the color layer, the form of a hot melt sheet may also be thermally laminated. An adhesive layer including 98 parts by weight of an acrylic copolymer and 2 parts by weight of an epoxy curing agent was formed to a thickness of 35 μm on the lower surface of the color layer. A color protective film for vehicles was manufactured by laminating a silicone protective film and a release film having an air track pattern (square lattice length 0.25 mm, depth 5 to 10 μm) on the upper surface of the self-healing layer and the lower surface of the adhesive layer, respectively.

### Comparative Example 1

A PVC color wrapping film (product name: Wrap Film Series 1080) sold by 3M, that is, Comparative Example 1 corresponds to a color protective film for vehicles including a PVC film as a substrate layer.

### Comparative Example 2

A color PPF made of a conventional TPU material, that is, Comparative Example 2 corresponds to a color protective film for vehicles in which a color is directly implemented in a thermoplastic polyurethane. The color protective film for vehicles has a structure in which a general release film to which an air track pattern is not applied, an adhesive layer, a color layer, a TPU film, a self-healing layer, and a silicone protective film are sequentially stacked. The color layer was applied directly to a TPU film using a coating method instead of a hot melt method.

### EXPERIMENTAL EXAMPLE

The impact resistance, scratch recovery, water repellency, adhesive properties, tensile strength, and the like of the color protective film for vehicles of the present invention were evaluated.

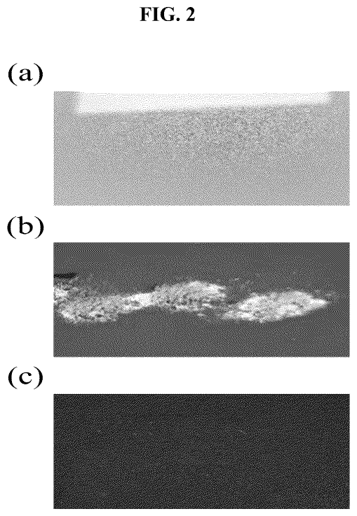

FIG. 2 is a set of images showing the impact resistance test results of a color protective film for vehicles according to the experimental example of the present invention. In FIGS. 2 to 7, (a), (b), and (c) refer to Example 1, Comparative Example 1, and Comparative Example 2, respectively.

The impact resistance was tested using a gravelometer, and referring to FIG. 2, it can be confirmed that Comparative Example 1, which is used simply for the purpose of changing the color of a vehicle, suffered significant surface damage, whereas Example 1 did not suffer any surface damage. Unlike the color protective film for vehicles of the present invention, Comparative Example 1 means simply changing the color and not being able to protect the paint.

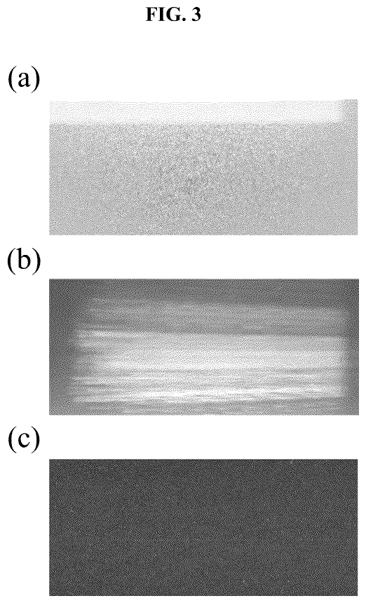

FIG. 3 is a set of images showing the scratch recovery test results of a color protective film for vehicles according to the experimental example of the present invention.

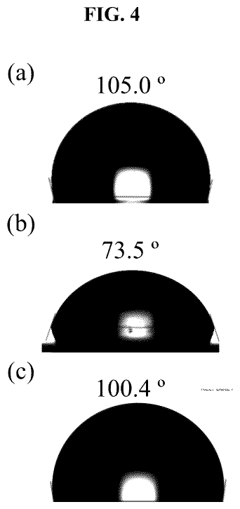

The scratch recovery is a result of testing the surface through a rubbing test under 500 reciprocating conditions at 80 rpm using steel wool (#0000), and referring to FIG. 3, it can be seen that Comparative Example 1 had no recovery performance compared to Example 1 and could not be protected against scratches that may be generated by tree branches or external impacts while the vehicle is in operation. FIG. 4 is a set of images showing the water repellency test results of a color protective film for vehicles according to the experimental example of the present invention.

The water repellency of the surface was measured using a contact angle meter, and referring to FIG. 4, Comparative Example 1 had no water repellency due to a very low contact angle, meaning that Comparative Example 1 had no function of preventing the contamination of the surface.

As described above, it can be confirmed that Comparative Example 1 is simply a means for changing the color of a vehicle and does not have any performance for protection, whereas the color protective film for vehicles of the present invention can protect the painted surface of the vehicle and simultaneously change the color.

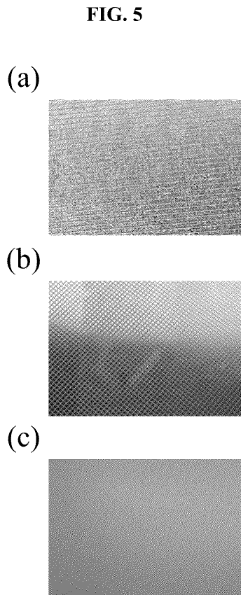

FIG. 5 is a set of photographs of the adhesive surface of a color protective film for vehicles according to the experimental example of the present invention.

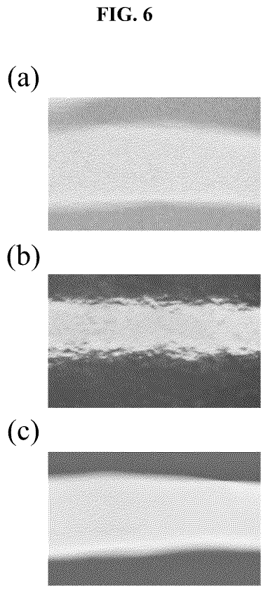

FIG. 6 is a set of photographs of the product surface of a color protective film for vehicles according to the experimental example of the present invention.

Referring to FIGS. 5 and 6, Comparative Example 1 has an air track which allows air bubbles on the adhesive surface to escape in order to enable dry application, but since a PVC material is relatively hard, an air track is formed in a large pattern to easily remove air bubbles. It can be confirmed that such large pattern shapes induce a phenomenon such as orange peel (OP), resulting in poor appearance.

In the case of Comparative Example 2, the appearance is quite good because no air track is applied, but there is a problem in that application can be performed only in a wet state because application cannot be performed in a dry state.

Unlike Comparative Example 2, Example 1 can be applied in a dry state using an air track, and has a much better appearance than Comparative Example 1 because the air track size is smaller than that of Comparative Example 1. When a paint is actually applied to a vehicle, such a difference in appearance may have a significant impact on user satisfaction, given that the essential purpose of changing the color of a vehicle is to make the vehicle look stylish.

The adhesive strength was measured for 30 minutes on a SUS304 substrate using a UTM apparatus. The results of measuring the adhesive strength are shown in the following Table 1.

TABLE 1

| | | Comparative | Comparative |
|---|---|---|---|
| | Example 1 | Example 1 | Example 2 |
| Adhesive strength | 400 | 500 | 1,300 |
| (gf/inch) | | | |

In the case of wet application, an application solution needs to be attached through squeezing even when the application solution is sprayed, so that the application solution needs to have a relatively high adhesive strength, whereas the application solution needs to have a low adhesive strength in order to enable application in a dry state. Example 1 has adhesive strength at a level equal to or lower than that of Comparative Example 1, which is applied in a dry state, and thus is very suitable for dry application.

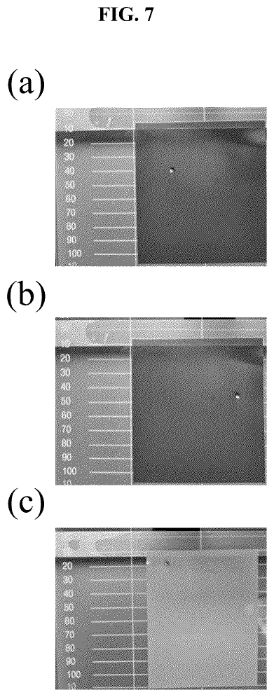

FIG. 7 is a set of images showing the results of evaluating the adhesive tack of a color protective film for vehicles according to the experimental example of the present invention.

The adhesive tack was evaluated using a Ball Tack Tester and under the conditions of a tilt of 10°/Ball 4/32. Referring to FIG. 7, it can be confirmed that Example 1 has a lower adhesive tack than Comparative Example 2.

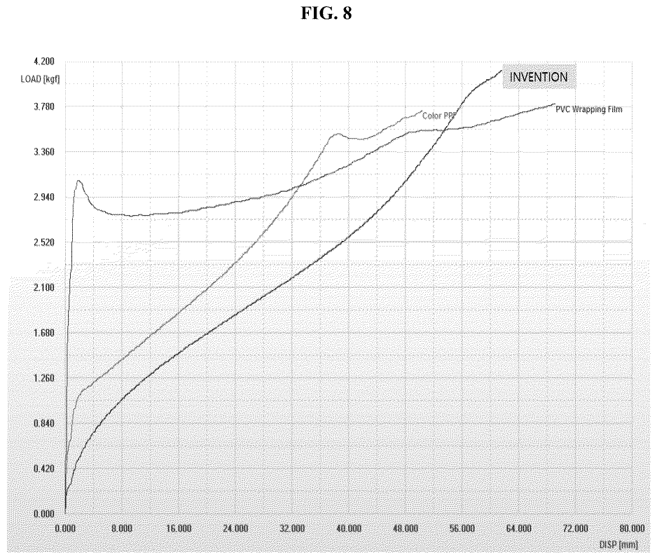

FIG. 8 is a graph showing the results of evaluating the tensile strength of a color protective film for vehicles according to the experimental example of the present invention.

The tensile strength was measured using a UTM apparatus, and is a result obtained by measuring tensile strength up to the point where the coating of the self-healing layer on the surface cracked. Referring to FIG. 7, it can be confirmed that the initial tensile strength of Comparative Example 1 is 2.9 kgf or more, and is maintained at a similar value thereafter. This means that Comparative Example 1 maintains its shape when stretched without any elasticity, and when stretched on a vehicle for application, Comparative Example 1 may maintain its shape without any resilience, enabling dry application. However, since the initial tensile strength is relatively very high, there is a limitation that a material needs to be heated using an apparatus such as a hot air blower during application to soften the material sufficiently and then apply the material.

Comparative Example 2 has a relatively low initial tensile strength, but exhibits characteristics that the tensile strength increases continuously as Comparative Example 2 is stretched. This means that the product is elastic. Therefore, when the product is applied to a vehicle, the edge portions may lift up due to the resilience caused by the elasticity after application by stretching the product, so that the adhesive strength and adhesive tack need to be high, and application cannot be performed in a dry state for this reason.

In contrast, it can be confirmed that Example 1 has a lower initial tensile strength than Comparative Examples 1 and 2 and the slope of the graph showing the increase in tensile strength and the tensile strength at the same elongation are also low. This means that the elasticity of the product is lower than that of Comparative Example 2, but by lowering the elasticity, it is possible to suppress the lifting even during application to the edge portion of the product, and as a result, dry application can be performed with low adhesive strength and adhesive tack.

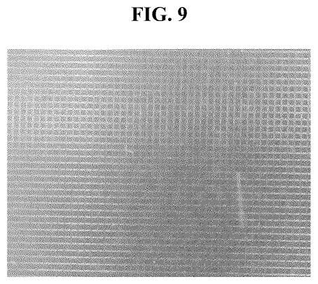

FIG. 9 is a photograph showing the surface of a release film having an air track pattern according to an embodiment of the present invention. By laminating a release film with a grid pattern engraved on it, as shown in FIG. 9, to the adhesive layer, air tracks capable of discharging allow air bubbles are produced in the adhesive layer, enabling dry application.

The color protective film for vehicles according to the embodiments of the present invention has improved application property by appropriately reducing the thickness of a substrate layer, and can also be applied in a dry state by lowering the tensile strength to a level that maintains the overall durability or protection performance of the product and applying an air track pattern that facilitates the discharge of air bubbles.

In addition, since the color layer of the color protective film for vehicles can be manufactured as a semi-finished product in the form of a separate sheet, and then can be laminated using a hot melt method as needed during application to use the color protective film for vehicles, the color protective film for vehicles is very advantageous for long-term storage and production of a wide variety of products in small quantities.

The effects according to the embodiments of the present invention are not limited to the contents exemplified above, and more various effects are included in the present specification.

As described above, although the present invention is mainly described with reference to the embodiments of the present invention, this is merely an example and does not limit the present invention, and it will be appreciated that a person with ordinary skill in the art to which the present invention pertains can make various modifications and applications which are not exemplified above within a range not departing from the essential characteristics of the embodiments of the present invention. For example, each constituent element specifically shown in the embodiments of the present invention can be modified and implemented. And differences related to these modifications and applications should be construed as being included in the scope of the present invention defined in the appended claims.

What is claimed is:

1. A color protective film for vehicles, comprising: an adhesive layer having an air track pattern formed;
a color layer disposed on the adhesive layer and comprising a thermoplastic polyurethane, an isocyanate curing agent, and a colored pigment;
a substrate layer disposed on the color layer and comprising a thermoplastic polyurethane; and
a self-healing layer disposed on the substrate layer.

2. The color protective film of claim 1, wherein the substrate layer has a thickness of 100 to 130 μm.

3. The color protective film of claim 2, wherein the self-healing layer has a thickness of 5 to 40 μm,
the color layer has a thickness of 5 to 60 μm, and
the adhesive layer has a thickness of 10 to 70 μm.

4. The color protective film of claim 1, further comprise a release layer disposed below the adhesive layer,
wherein the release film has a pattern corresponding to the air track pattern formed.

5. The color protective film of claim 1, wherein the color layer comprises:
80 to 90 parts by weight of a thermoplastic polyurethane;
5 to 8 parts by weight of an isocyanate curing agent; and
10 to 20 parts by weight of a colored pigment.

6. The color protective film of claim 1, wherein the adhesive layer comprises 94 to 99 parts by weight of an acrylic copolymer and 0.5 to 5 parts by weight of an epoxy curing agent, and
the self-healing layer comprises 75 to 90 parts by weight of polyurethane methacrylate and 15 to 40 parts by weight of an isocyanate curing agent.

7. The color protective film of claim 1, further comprising a silicone protective film disposed on the self-healing layer.

8. The color protective film of claim 1, wherein the color protective film for vehicles is for dry application.

9. A method for manufacturing a color protective film for vehicles, the method comprising: (a) preparing a semi-finished product of a color protective film for vehicles by laminating a color layer to a substrate layer using a hot melt method;
(b) coating a self-healing layer on the substrate layer of the semi-finished product and an adhesive layer under the color layer to form the self-healing layer and the adhesive layer; and
(c) laminating a release film under the adhesive layer,
wherein an air track pattern is formed on the adhesive layer.

10. The method of claim 9, further comprising laminating a silicone protective film on the self-healing layer.
